(19) United States
(12) Patent Application Publication
(10) Pub. No.: US 2011/0224103 A1
(43) Pub. Date: Sep. 15, 2011

(54) METHOD FOR DESIGN OF AN OLIGINUCLEOTIDE ARRAY

(75) Inventors: Nevenka Dimitrova, Pelham, NY (US); Sitharthan Kawalakaran, Pelham, NY (US); Robert Lucito, East Meadow, NY (US)

(73) Assignees: KONINKLIJKE PHILIPS ELECTRONICS N.V., EINDHOVEN (NL); COLD SPRING HARBOR LABORATORY, Cold Spring Harbor, NY (US)

(21) Appl. No.: 12/993,917

(22) PCT Filed: May 14, 2009
(86) PCT No.: PCT/IB2009/052006

§ 371 Date: Nov. 22, 2010

Related U.S. Application Data
(60) Provisional application No. 61/056,145, filed on May 27, 2008.

(51) Int. Cl. C40B 50/02; C40B 60/14

(52) U.S. Cl. 506/24; 506/40

(57) ABSTRACT

A method is provided allowing for automatic selection of enzymes to be used in protocols such as methylation profiling, chip-on-chip, and comparative genomic hybridization experiments. The method may also maximize the space on a micro array for a given experiment. This means that the results from the micro array are improved. The method also improves zero-in and focus of significant patterns on a micro array. This enhances the ability to distinguish two separate classes of samples, e.g. tumour vs. normal, aggressive vs. non-aggressive, male vs. female, etc. Furthermore, a computer readable medium and a device are also provided.

### FIELD OF THE INVENTION

This invention pertains in general to the field of oligonucleotide array validation. More particularly the invention relates to a method and even more particularly to a computer readable medium.

### BACKGROUND OF THE INVENTION

An oligonucleotide array is a chip where a multitude of oligonucleotide sequences, such as DNA sequences, are fastened in a specific pattern.

Depending on what mechanism one wishes to study, different oligonucleotide arrays may be designed. For example, DNA methylation, which may be studied with one specific type of microarray called Methylation Oligonucleotide Microarray Analysis (MOMA), is the most well studied epigenetic mechanism of gene regulation. It is known that DNA methylation of so called CpG rich areas, present in the promoter region, may act as a mechanism for gene silencing. A CpG island is a part of the genome rich in the nucleotides C and G.

Methods for experimentally finding the differential methylation, well known to a person skilled in the art, include differential methylation hybridization, methylation specific sequencing, HELP assay, bisulphite sequencing, CpG island arrays etc.

However, there are many more applications for which genomic representations may be used to query the genome to find, e.g. DNA-protein interactions, gene copy number polymorphisms, differential methylation loci, etc.

When performing analysis on arrays, there is always a problem of choosing which sequences are going to be on the array. One would prefer as many as possible, but even with high-density arrays, there is not enough room. Standard Agilent arrays nowadays contain 244,000 probes and Nimblegen arrays cover 395,000 probes. On Nimblegen arrays, where probes are 50 bases long there are 20,000,000 genomic sequences. Compared to the 3,000,000,000 bases in the human genome it is obvious that choices have to be made regarding which sequences to prioritize for placement on the array. The traditional way of choosing the sequences that will be covered by the array is by educated guesses or trial and error.

Hence, an improved method for designing arrays would be advantageous and in particular a method for designing arrays allowing for increased flexibility, cost-effectiveness and/or possibility to validate the designed array would be advantageous.

### SUMMARY OF THE INVENTION

Accordingly, the present invention preferably seeks to mitigate, alleviate or eliminate one or more of the above-identified deficiencies in the art and disadvantages singly or in any combination and solves at least the above mentioned problems by providing a device, a method, a computer-readable medium, and a database, according to the appended patent claims.

An object of the invention is to provide a method for design and validation of an oligonucleotide array.

According to one aspect of the invention, a method is provided, according to which information about genome annotations and desired sequences is saved in a first database. Then, a representation matrix for query sequences is constructed by applying a second database on the information stored in the first database. The second database may comprise information about restriction enzymes. Subsequently, a list of restriction enzymes and a list of sequences for profiling are constructed from the representation matrix for query sequences. Finally, an oligonucleotide array is designed from the list of sequences.

According to another aspect of the invention, use of a method according to above, wherein said second database further comprise information regarding a desired restriction enzyme and/or the order of which said restriction enzyme is to be applied is disclosed, for designing an in silico protocol for validation of oligonucleotide arrays is disclosed.

According to yet another aspect of the invention, a computer readable medium is disclosed. The computer readable medium has embodied thereon a computer program for processing by a processor. The computer program comprises code segments suitable for performing the method according to above.

Furthermore, according to an aspect of the invention a device for validation of an oligonucleotide array is disclosed. The device comprises units suitable for performing the method according to above.

The present invention has the advantage over the prior art that it allows automatic selection of enzymes to be used in protocols for methylation profiling, chip-on-chip, and comparative genomic hybridization experiments. The present invention also maximizes the space on a micro array for a given experiment. This means that the results from the micro array are improved. The present invention also improves zero-in and focus of significant patterns on a micro array. This enhances the ability to distinguish two separate classes of samples, e.g. tumour vs. normal, aggressive vs. non-aggressive, male vs. female, etc.

### BRIEF DESCRIPTION OF THE DRAWINGS

These and other aspects, features and advantages of which the invention is capable of will be apparent and elucidated from the following description of embodiments of the present invention, reference being made to the accompanying drawings, in which

FIG. 1 is a schematic illustration of the array design process according to one embodiment;

FIG. 2 is a schematic illustration of a computer readable medium having embodied thereon a computer program for processing by a processor;

FIG. 3 is a schematic illustration of a device for design and validation of oligonucleotide arrays;

FIG. 4 is a further, more detailed schematic illustration of the array design process illustrated in FIG. 1;

FIG. 5 is a schematic illustration of a process according to another embodiment;

FIG. 6 is a schematic illustration of a third embodiment that is an ensemble method of the embodiments presented in FIG. 4 and FIG. 5;

FIG. 7 is a schematic illustration of a process according to a further embodiment;

FIG. 8 is showing histograms visualizing distribution of fragments of the protein MseI according to one embodiment. FIG. 8A is showing size distribution. The y-axis represents frequency 81 and the x-axis represents size 82. FIG. 8B is showing the coverage distribution. The y-axis represents frequency 81 and the x-axis represents coverage 83; and

FIG. 9 is showing histograms visualizing distribution of fragments of the protein MspI according to one embodiment. FIG. 9A is showing size distribution. The y-axis represents frequency 91 and the x-axis represents size 92. FIG. 9B is showing the coverage distribution. The y-axis represents frequency 91 and the x-axis represents coverage 93.

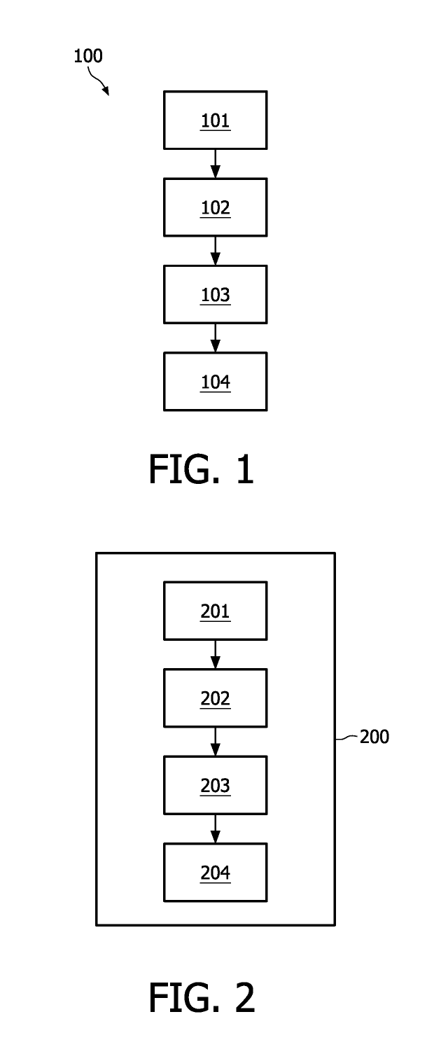

### DESCRIPTION OF EMBODIMENTS

According to one embodiment, a method is provided allowing for automatic selection of enzymes to be used in protocols. These protocols may be methylation profiling, chip-on-chip, and comparative genomic hybridization experiments. According to one embodiment, the method may also maximize the space on a micro array for a given experiment. This means that the results from the micro array are improved. The method may also improve zero-in and focus of significant patterns on a micro array. This enhances the ability to distinguish two separate classes of samples, e.g. tumour vs. normal, aggressive vs. non-aggressive, male vs. female, etc.

Several embodiments of the present invention will be described in more detail below with reference to the accompanying drawings in order for those skilled in the art to be able to carry out the invention. The invention may, however, be embodied in many different forms and should not be construed as limited to the embodiments set forth herein. Rather, these embodiments are provided so that this disclosure will be thorough and complete, and will fully convey the scope of the invention to those skilled in the art. The embodiments do not limit the invention, but the invention is only limited by the appended patent claims. Furthermore, the terminology used in the detailed description of the particular embodiments illustrated in the accompanying drawings is not intended to be limiting of the invention.

The following description focuses on an embodiment of the present invention applicable to a method and in particular to a method for designing arrays. However, it will be appreciated that the invention is not limited to this application but may be applied to many other applications including for example in silico protocols for designing PCR-based experiments. In this case an additional verification is needed to make sure that target DNA sequences are available in the final product and that the right probes are selected for amplification.

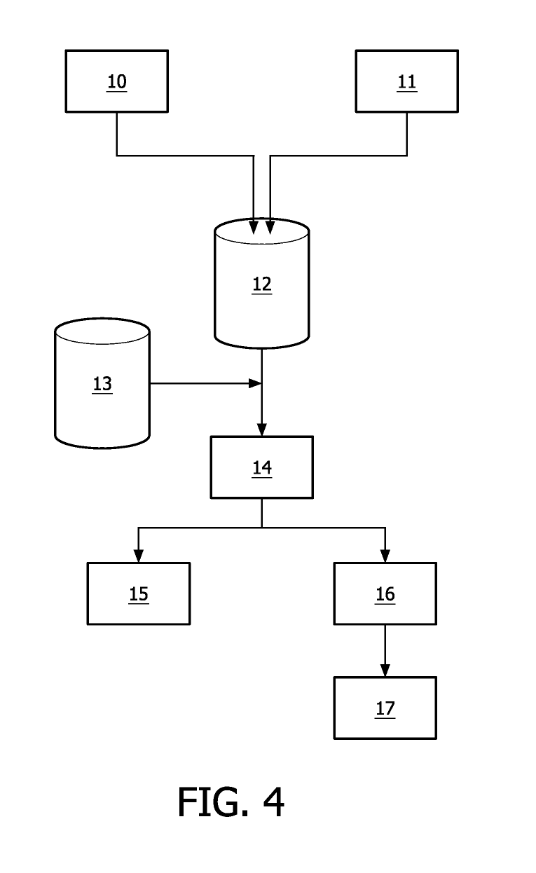

In an embodiment according to FIG. 4, a method 100 for validation of oligonucleotide arrays is provided. Examples of oligonucleotides may be DNA, RNA, cDNA etc.

According to an embodiment, the oligonucleotide array are DNA array. According to a further embodiment, the DNA array is a DNA methylation array.

According to another embodiment, the DNA array is a gene expression profile.

According to yet another embodiment, the DNA array is a genomic profiling array. The genomic profiling array 17 may according to some embodiments be a single nucleotide polymorphism array or gene copy number polymorphism array.

According to an embodiment, the method 100 comprises storing information about genome annotations 10 and desired sequences 11 in a first database 12 comprising the sequences of interest which need to be covered in the in silico designed protocol.

According to one embodiment, the information about genome annotations 10 is e.g. information about CpG islands in a genome and/or gene promoters. According to another embodiment, the information about desired sequences 11 are regions of interest. The regions of interest may be e.g. oncogenes, tumor suppressors, microRNAs, telomerase, centromeres and/or repeats.

Further, a representation matrix for query sequences 14 is constructed. This may be done by applying a second database 13. The database 13 may comprise all the known enzymes and their respective recognition and cutting sites (sequences). The database 13 may also comprise information about what enzymes are suitable for use and/or what order the enzymes are to be applied.

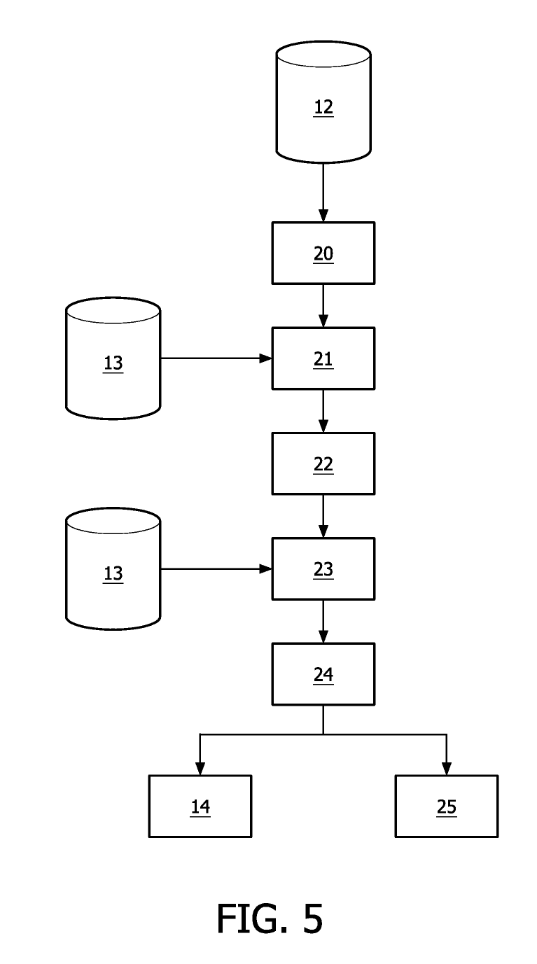

A list of restriction enzymes 15 and a list of sequences suitable for methylation profiling 16 may then be constructed from the representation matrix for query sequences 14. The step 14 may comprise numerical representations of what is available in the FIG. 5. The ideal enzyme will have all fragments having 100% coverage (left column in the figure) with no bars in the histogram that are at 0%. Also the fragment length distribution will fall in the 200-1000 base range. According to one embodiment, these conditions may be set dynamically in the process and change according to the type of array being designed. This is because the arrays can be a fixed length array as well as a variable length array. Thus the length of the probes may vary. This means that different size fragments and different size probes may be selected with the in silico digestion. A DNA methylation array 17 may then be constructed from the list of sequences. Thus the methylation array 17 comprises fragments that have passed the filter 22 according to FIG. 5. The probes are then designed according to standard criteria for each fragment and synthesized on the array according to methods known to a person skilled in the art. The number of probes that can be put on the array is only limited by the technical limitations of array manufacturing.

According to one embodiment, the method 100 may be used to design in silico protocol for validation of DNA arrays.

The process leading to the representation matrix for query sequences 14 is further illustrated in FIG. 5. A DNA sequence 20, stored in the first database 12, is digested in silico with a first restriction enzyme 21, stored in the second database 13. According to one embodiment, the DNA sequence 20 is a complete genome. According to another embodiment the DNA sequence 20 is a genomic sequence of all known genes. According to yet another embodiment the DNA sequence 20 is a sequence of computationally or experimentally derived islands. The islands may be e.g. CpG islands or acetylation islands. Based on the restriction enzyme recognition site and its cutting site, the first in silico digestion produces all the possible fragments.

A first filtering criterion 22 is then applied to sort the fragments from the first digestion 21. Sorting is performed based on fragment length, which may be empirically derived values for the desired range, such as 200-1000. Only fragments within this range pass the filter and are used in the next step.

The filtering 22 may remove fragments based on criteria which are empirically derived. For example, fragments with length lower than 200 bp and higher than 2000 bp may be removed. The filtered fragments are then subjected to a second in silico digestion 23, based on information stored in the database 13. After the second in-silico digestion, the fragments may be cut into smaller pieces by using a subsequent in-silico digestion with a different enzyme. The second in silico digestion 23 may be done in order to remove certain sequences that are remaining from the first digestion step 21.

For example, the first digestion 21 may optimize to get most of known genes plus some extra repeat sequences from a database of the whole genome sequence 12. In this situation, a second in silico digestion step 23 is required. So the output of the sequences from the first digestion 21 is given as input for the second step 23. Now another step of in silico digestion 23 is performed using the database of restriction enzymes 13 to identify the best enzyme that removes all the repeat sequences and keeping the known gene parts in the desired fragment length range.

According to a further embodiment, any number of additional in silico digestions, analogous to the first digestion 21 and the second digestion 23, may be carried out if necessary. Between each in silico digestion may be carried out. The filtering criterion may be analogous to the first filtering criterion 22.

A distribution of fragments 24 according to length is then achieved. The distribution of fragments 24 may be visualized with distribution histograms 25 and/or stored in a representation matrix for query sequences 14.

TABLE 1
Total coverage of genomic length after applying MspI, NotI and MseI

| | Length | MspI | NotI | MseI |
|---|---|---|---|---|
| Total Takai CpG | 42.7 MB | 14 MB | 0.16 MB | 31 MB |
| island length | | | | |
| % | | 33.15% | 0.38% | 72.7% |
| Total Gardiner | 140 MB | 63 MB | 0.2 MB | 115 MB |
| CpG island length | | | | |
| % | | 44.9% | 0.1% | 82.05% |

The table makes clear how to decide about which enzyme to use in the final protocol. The application of each enzyme produces different length coverage of the desired target group of sequences. For example, in this case, MseI produces the largest coverage—31 MB of the target sequences which total 42.7 MB for Takai-Jones definition. Same is true for the Gardiner definition. Thus, the largest coverage for MseI is achieved both according to Takai CpG island length and according to Gardiner CpG island length.

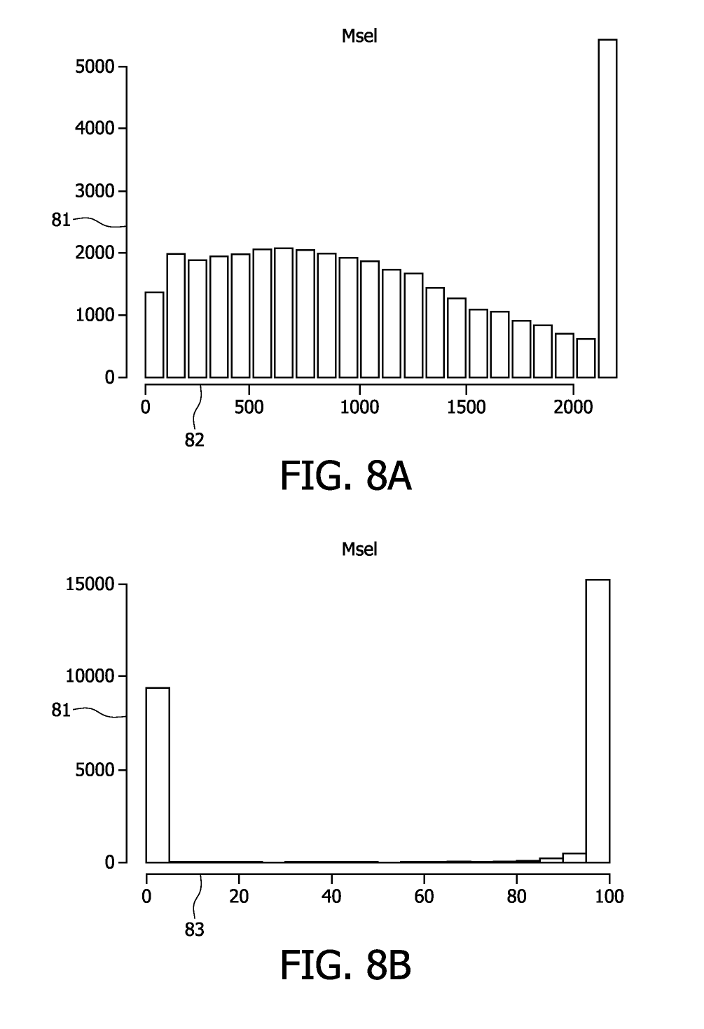

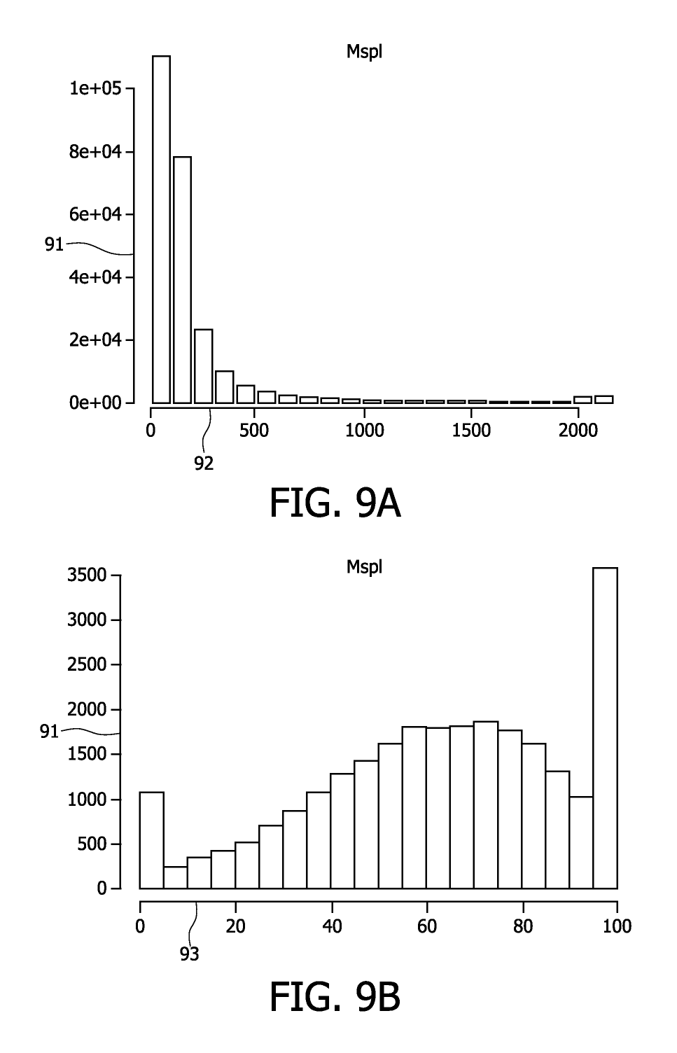

Examples of the histograms 25 are shown in FIGS. 8 and 9. FIG. 8 shows the result with enzyme MseI and FIG. 9 shows results with enzyme MspI. The numerical results of FIGS. 8 and 9 originates from the second database 13 of FIG. 4 and step 21 in FIG. 5 and may be evaluated from the representation matrix for query sequence 14, by the filtering criterion 22. The histograms show different genomic lengths after in silico digestion with various restriction enzymes, after removing fragments with length lower than 200 bp and higher than 2000 bp, and after removing fragments that cover CpG islands less than 50% of their length. FIGS. 8A and 9A show histograms where the bins are length (first bin is 0-100 nucleotide length, 101-200 length, etc), so it reflects how many fragments are of particular nucleotide length. The histograms thus show the length-wise distribution of the fragments. FIGS. 8B and 9B show histograms where the bins are percentage (e.g. 0-10%, 11-20% . . . ) of the fragments that cover (intersect with) CpG islands.

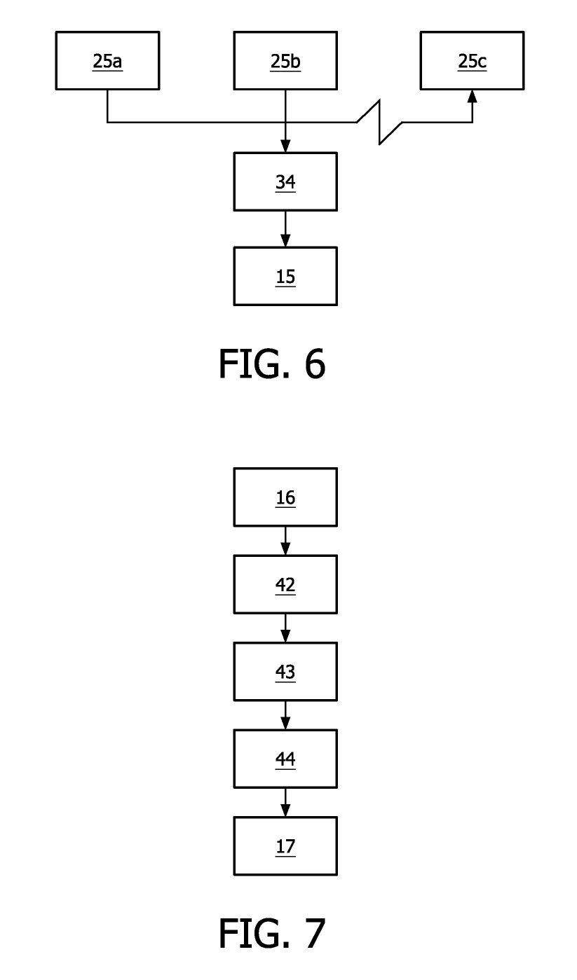

In another embodiment according to FIG. 6, a method for evaluating distribution histograms 25 is provided. The evaluation is based on the number of fragments in each bin of histograms 25a, 25b, 25c etc. compared to the coverage wanted. A first histogram 25a may have one set of properties. Another histogram 25b may have another set of properties. Yet another histogram 25c, may have yet another set of properties. Between histogram 25b and 25c, any number of histograms may be subject for evaluation 34. Each histogram corresponds to the digestion with a different enzyme. A favourable distribution of fragments is selected, based on the evaluation 34. This is the list of restriction enzymes 15. One good example is a histogram that has bins, which are evenly distributed rather than a single bin dominating the others. A list of criteria which dictate for individual bins is set according to: H(i) i=1, . . . n, for each histogram H:

H(i)>=hₘᵢₙ(e.g. hₘᵢₙ=0.1) (i)

H(i)<=hₘₐₓ (e.g. hₘₐₓ=0.8) (ii)

ΣH(i)=0.9 for i=2, n−1 (iii)

At each digestion step, it is possible to change the set of rules depending on the desired result.

According to one embodiment, after the successful evaluation of the order of the enzymes that need to be applied in order to produce a desirable collection of fragments, the best possible probes for given fragments may be selected and placed on a microarray. According to another embodiment, after the successful evaluation of the order of the enzymes that need to be applied in order to produce a desirable collection of fragments, the best possible primers for a PCR reaction may be selected. In one embodiment according to FIG. 7, a method for selecting probes with desired properties is provided. The input for this method is the list of sequences for methylation profiling 16. The sequences are prioritized 42, such as ranked or sorted, based on a criterion resulting in a second set of sequences suitable for use on a particular oligonucleotide array. This may be based on their length (very short fragments and very long fragments are excluded, e.g. fragment with a length less than 200 or greater than 1000 bases). The fragments may also be prioritized based on the genome annotation relevant for their respective sequence. The prioritization is higher for fragments on exons, promoters, miRNAs, CpG islands, 3'UTR, (histone) acetylation islands, particular histone modification islands (e.g. Histone 3 lysine 4 monomethylation islands). In other embodiments, particular repetitive regions might be of interest (e.g. LINES, SINES). Next, for these fragments probes may be designed that may be representative of the fragment on the microarray. In addition, fragments are prioritized 42 based on nucleotide frequency content, i.e. mono-, di-, and tri-, using a hybridization model. A hybridization model is a classification model, which predicts probe performance on microarrays. For example, a support vector machine classifier, which is trained to classify “good” from “bad” probes is a classification model for probe design and selection. Values of parameters such as frequency of nucleotides (mono-, di- and tri-), secondary structure score, ability to match probes on the array etc. are constructed. Then, a profile according to a hybridization model is applied 43 for a given array type to sort out the best probes to match these fragments based on a hybridization classification model. The classification model takes into account a number of sequence and thermodynamics features. Sequence features comprise frequencies of mono- di- and trinucleotides. Thermodynamic features comprise entropy, enthalpy, melting temperature, propeller twist, DNA bendability etc.

For both fragment and its representative probe, the following features may be computed based on the sequence: number of nucleotides not forming a loop, CG content at the 3′ end, frequency content of trinucleotides, e.g. TCC, CTC, TGG, AGG, GCC, melting temperature (Tm), bendability, stacking energy, propeller twist, aphilicity, protein-induced deformability, duplex stability—free energy, duplex stability—disrupt energy, DNA denaturation, DNA bending stiffness, B-DNA twist, protein-DNA twist and/or stabilizing energy of Z-DNA. This may be done using any of the public computational tools (or databases) known in the art, for example, DNA scanner according to Prabhat K. Mandal, Kamal Rawal, Ram Ramaswamy, Alok Bhattacharya, and Sudha Bhattacharya, Identification of insertion hot spots for non-LTR retrotransposons: computational and biochemical application to Entamoeba histolytica, Nucleic Acids Res. 2006 November; 34(20): 5752-5763.

Based on decision rules (e.g. a profile) developed from a hybridization classification model, the values of these features should be matched against the profile using a distance metric. The closest match to the profile for a probe-fragment pair is selected 44 as a probe for the oligonucleotide array 17.

The following is an example of two MspI fragments (sequences) and their corresponding features.

According to one embodiment, liven a sequence SEQ ID NO 1;

CGGCTCGCTCGCGAAGCCACGGGCTTCACTGACGCGACTTTCCAAGACG
TGGGGGTCACCATGGGCAGAGGACATCGGTTCGGAGCCAGATCACGGGC
CCCATAAGCATCAGACCATAAGCAGCGCCGCCACTGAGAGCCGCTCGGA
ACTCGCCCAGCATGTCGGGTCCCCTAGCCAGGGCCTGGTGTACGTGGTC
GAGGGCCCTGGAAGCCCCGATGGCCTAGGAGGAGCAGGCGGGCGGGGCG
GCGGGTGTCGCTGG,

the features in a feature matrix may be computed. The names of these features are given in table 2. Features 1-4 are the normalized frequencies of mononucleotides, A, C, G, T in the sequence. Features 5-20 are frequencies of dinucleotides, i.e.

AA's, AC's, AG's, AT's, CA's, CC's, CG's, CT's, GA's, GC's, GG's, GT's, TA's, TC's, TG's, TT's. Features 21-84 are normalized frequencies of trinucleotides, such as ATT, ATA, ATG. Features 85-103 are so called thermodynamic features. Features 104-107 are secondary structure features.

The following are feature values for SEQ ID NO 1:

| >Gene = NM_005427 StartPos = 3557771 Length = 259 | | | | 0.181467 | 0.312741 |
|---|---|---|---|---|---|
| | 0.366795 | 0.138996 | 0.023166 | 0.046332 | 0.081081 |
| | 0.030888 | 0.073359 | 0.092664 | 0.096525 | 0.050193 |
| | 0.065637 | 0.111969 | 0.142857 | 0.042471 | 0.019305 |
| | 0.057915 | 0.046332 | 0.015444 | 0.000000 | 0.007722 |
| | 0.011583 | 0.011583 | 0.000000 | 0.000000 | 0.019305 |
| | 0.003861 | 0.000000 | 0.019305 | 0.023166 | 0.038610 |
| | 0.015444 | 0.003861 | 0.019305 | 0.007722 | 0.003861 |
| | 0.000000 | 0.000000 | 0.011583 | 0.000000 | 0.007722 |
| | 0.007722 | 0.003861 | 0.011583 | 0.007722 | 0.027027 |
| | 0.000000 | 0.000000 | 0.015444 | 0.034749 | 0.007722 |
| | 0.003861 | 0.003861 | 0.015444 | 0.019305 | 0.007722 |
| | 0.011583 | 0.027027 | 0.019305 | 0.023166 | 0.023166 |
| | 0.050193 | 0.042471 | 0.019305 | 0.019305 | 0.027027 |
| | 0.046332 | 0.007722 | 0.007722 | 0.019305 | 0.015444 |
| | 0.023166 | 0.003861 | 0.027027 | 0.019305 | 0.007722 |
| | 0.015444 | 0.042471 | 0.030888 | 0.015444 | 0.034749 |
| | 0.011583 | 0.030888 | 2284.420000 | | 2934.320000 |
| | 141.560000 | 597.100000 | 486.900000 | 1436.000000 | |

| 23681.910000 | 20330.000000 | | 9145.600000 |
|---|---|---|---|
| 8785.200000 | 350.000000 | 749.100000 | 5544.600000 |

| 2253900.000000 | | 3946.000000 | 20.683000 | |
|---|---|---|---|---|
| 522.000000 | 124.411417 | 600777.510000 | 133 | 159 |
| 108 | 113 | | | |

In a similar way, SEQ ID NO 2;

AAAAAGGAAATTGAGAAGAAAGAAAATCAAAGGGAAGCAAAATCACTCA
CTCTCACTACCTCAAGATACCCTCTAGAAGTTGGTATTTTAGTGTGGTT
CCTATTGTTTTCTGTGTCAGTTCTCTGATTTGAGCAAAATCTTTGGGAC
GTCAAACTTAAAATCCCCTTTACTTCCTTGGAAACCCTGTAGCATTAGC
CCAGACATGTCCCTACTCCTCCTTGTGGCAAAGAGAAGGATCTCGTCTT
TGGTCCCCAGAGTTCTGGCCTAAGCCTCCCTCCAGGAGGGAAGATGAGT
GTTCAGACACTCAGAGTAGCTGGGGGAGACACAGGCCTGTGAAATTATC
CTGGCTCAACTATTAGGTCGGCAGAATCCCAGTGAAGGGAGCCCTACCT
CTGAGCCCCATCTAAGCTTTGGCTATGGGTGGGGCAGATAAGCAGGAAT
CCATCCCTATAGGCTCAATGCCAACACCCTTAGGTGAAACTCTTGATGA
AACTTGAGGCCAGGGCT,

gives the following features:

| >Gene = NM_006142 StartPos = 27060220 Length = 507 | | | 0.276134 | |
|---|---|---|---|---|
| 0.238659 | 0.232742 | 0.252465 | 0.096647 | |
| 0.041420 | 0.088757 | 0.049310 | 0.061144 | |
| 0.080868 | 0.005917 | 0.090730 | 0.071006 | |
| 0.041420 | 0.072978 | 0.047337 | 0.045365 | |
| 0.074951 | 0.065089 | 0.065089 | 0.013807 | |
| 0.005917 | 0.009862 | 0.019724 | 0.017751 | |
| 0.039448 | 0.027613 | 0.011834 | 0.013807 | |
| 0.029586 | 0.025641 | 0.019724 | 0.019724 | |
| 0.009862 | 0.001972 | 0.009862 | 0.017751 | |
| 0.013807 | 0.021696 | 0.011834 | 0.011834 | |
| 0.007890 | 0.015779 | 0.009862 | 0.017751 | |
| 0.021696 | 0.023669 | 0.001972 | 0.023669 | |
| 0.021696 | 0.003945 | 0.025641 | 0.011834 | |
| 0.005917 | 0.017751 | 0.011834 | 0.011834 | |
| 0.029586 | 0.021696 | 0.007890 | 0.011834 | |
| 0.019724 | 0.021696 | 0.019724 | 0.011834 | |
| 0.013807 | 0.000000 | 0.015779 | 0.021696 | |
| 0.019724 | 0.015779 | 0.031558 | 0.007890 | |
| 0.017751 | 0.023669 | 0.011834 | 0.003945 | |
| 0.000000 | 0.001972 | 0.000000 | 0.035503 | |
| 0.015779 | 0.000000 | 0.029586 | 3908.540000 | |
| 6539.090000 | 317.500000 | 974.600000 | 801.500000 | |
| 2273.600000 | 41997.750000 | | 32450.000000 | |
| 17988.800000 | 17254.000000 | | 478.000000 | |
| 1649.300000 | 10169.000000 | | 4013900.000000 | |
| 6793.000000 | 49.116000 | 716.000000 | 110.995686 | |
| 982012.650000 | 94 | 183 | 94 | 178. |

TABLE 2
Feature names for the above values:

| Feature | Feature |
|---|---|
| No. | Name |
| 1 | A's |
| 2 | C's |
| 3 | G's |
| 4 | T's |
| 5 | AA's |
| 6 | AC's |
| 7 | AG's |
| 8 | AT's |
| 9 | CA's |
| 10 | CC's |
| 11 | CG's |
| 12 | CT's |
| 13 | GA's |
| 14 | GC's |
| 15 | GG's |
| 16 | GT's |
| 17 | TA's |
| 18 | TC's |
| 19 | TG's |
| 20 | TT's |
| 21 | ATT |
| 22 | ATA |
| 23 | ATG |
| 24 | ATC |
| 25 | AAT |
| 26 | AAA |
| 27 | AAG |
| 28 | AAC |
| 29 | AGT |
| 30 | AGA |
| 31 | AGG |
| 32 | AGC |
| 33 | ACT |
| 34 | ACA |
| 35 | ACG |
| 36 | ACC |
| 37 | TTT |
| 38 | TTA |
| 39 | TTG |
| 40 | TTC |
| 41 | TAT |
| 42 | TAA |
| 43 | TAG |
| 44 | TAC |
| 45 | TGT |
| 46 | TGA |
| 47 | TGG |
| 48 | TGC |
| 49 | TCT |
| 50 | TCA |
| 51 | TCG |
| 52 | TCC |
| 53 | GTT |
| 54 | GTA |
| 55 | GTG |
| 56 | GTC |
| 57 | GAT |
| 58 | GAA |
| 59 | GAG |
| 60 | GAC |
| 61 | GGT |
| 62 | GGA |
| 63 | GGG |
| 64 | GGC |
| 65 | GGT |
| 66 | GGA |
| 67 | GGG |
| 68 | GGC |
| 69 | CTT |
| 70 | CTA |
| 71 | CTG |
| 72 | CTC |
| 73 | CAT |
| 74 | CAA |
| 75 | CAG |
| 76 | CAC |
| 77 | CGT |
| 78 | CGA |
| 79 | CGG |
| 80 | CGC |
| 81 | CCT |
| 82 | CCA |
| 83 | CCG |
| 84 | CCC |
| 85 | Stacking energy |
| 86 | Propellor |
| 87 | Philicity |
| 88 | Duplex Stability |
| | Disrupt Energy |
| 89 | Duplex Stability free |
| | Energy |
| 90 | Deformability |
| 91 | DNA denaturation |
| 92 | DNA bending stiffness |
| 93 | B-DNA Twist |
| 94 | Proteint-DNA twist |
| 95 | Content |
| 96 | Stabilizing |
| 97 | Entropy |
| 98 | Enthalpy |
| 99 | Positioning |
| 100 | Bendability |
| 101 | Trinuclotide |
| 102 | Tm Uniformity |
| 103 | DeltaG |
| 104 | Hairpin feature |
| 105 | Hairpin feature |
| 106 | Hairpin feature |
| 107 | Hairpin feature |

The list of restriction enzymes 15 are assigned a set of probes. The probes may confirm whether the desired fragment produces a signal (i.e. present) vs. no signal (i.e. absent) when attached to an array. For probe selection a hybridization model may be applied that is developed separately (again based on the knowledge of the application). The type of hybridization model used for CpG island arrays will be very different from the one used for comparative genomic hybridization.

Applications and use of the above described embodiments according to the invention are various and include exemplary fields such as High throughput (high end) discovery in life sciences, where companies such as Agilent and Roche (the Nimblegen part) make custom arrays for advanced experiments in methylation profiling, chip-on-chip experiments for studying DNA-protein interactions (e.g. histone modifications).

The same method 100 may be applied to develop a low cost microarray to be used in clinical diagnostics for infectious disease diagnostics, genetic screening, cancer testing. GE for example has a low cost microarray product line.

The methods according to some embodiments above, may also be performed by a unit. The unit may be any unit normally used for performing the involved tasks, e.g. a hardware, such as a processor with a memory. The processor may be any of variety of processors, such as Intel or AMD processors, CPUs, microprocessors, Programmable Intelligent Computer (PIC) microcontrollers, Digital Signal Processors (DSP), etc. However, the scope of the invention is not limited to these specific processors. The memory may be any memory capable of storing information, such as Random Access Memories (RAM) such as, Double Density RAM (DDR, DDR2), Single Density RAM (SDRAM), Static RAM (SRAM), Dynamic RAM (DRAM), Video RAM (VRAM), etc. The memory may also be a FLASH memory such as a USB, Compact Flash, SmartMedia, MMC memory, MemoryStick, SD Card, MiniSD, MicroSD, xD Card, TransFlash, and MicroDrive memory etc. However, the scope of the invention is not limited to these specific memories.

In an embodiment according to FIG. 2, a computer readable medium 200 is provided. The computer readable medium 200 comprises embodied thereon a computer program for processing by a processor, the computer program comprising, a first code segment 201 for saving information about genome annotations 10 and desired sequences 11 in a first database 12; a second code segment 201 for constructing a representation matrix for query sequences 14 by applying a second database 13 comprising information about restriction enzymes on the information stored in the first database 12; a third code segment 203 for constructing a list of restriction enzymes 15 and a list of sequences for profiling 16 based on the representation matrix; and a fourth code segment 204 for designing a DNA array 17 from the list of sequences.

According to one embodiment, the computer program is used for designing an in silico protocol for validation of DNA arrays.

In one embodiment, the computer program validates DNA methylation arrays. According to another embodiment, the computer program validates gene expression profiles. According to a further embodiment, the computer program validates genomic profiling arrays.

According to one embodiment, the computer program for in silico protocol design may be part of a specialized computer for assisting in preclinical or experimental research. According to a further embodiment, the computer program may be coupled to an automated microfluidic system, which takes “wet” input from multiple wells. The selection of input may be controlled based on the method 100.

The invention may be implemented in any suitable form including hardware, software, firmware or any combination of these. However, preferably, the invention is implemented as computer software running on one or more data processors and/or digital signal processors. The elements and components of an embodiment may be physically, functionally and logically implemented in any suitable way. Indeed, the functionality may be implemented in a single unit, in a plurality of units or as part of other functional units. As such, the invention may be implemented in a single unit, or may be physically and functionally distributed between different units and processors.

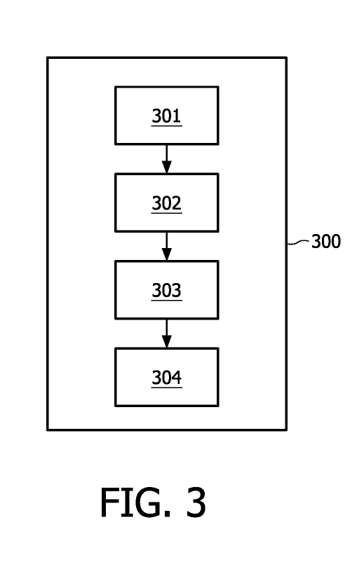

In an embodiment according to FIG. 3, a device 300 is disclosed. The device 300 comprises units for performing the method 100 according to some embodiments, e.g. for validation of DNA arrays. The device 300, comprises a first unit 301 configured to save information about genome annotations 10 and desired sequences 11 in a first database 12. The device 300 further comprises a second unit 302 configured to construct a representation matrix for query sequences 14 by applying a second database 13 comprising information about restriction enzymes on the information stored in the first database 12. Furthermore, the device 300 comprises a third unit 303 configured to constructing a list of restriction enzymes 15 and a list of sequences for profiling 16 based on the representation matrix. Finally, the device 300 comprises a fourth unit 304 configured to design a DNA array 17 from the list of sequences.

Although the present invention has been described above with reference to specific embodiments, it is not intended to be limited to the specific form set forth herein. Rather, the invention is limited only by the accompanying claims and, other embodiments than the specific above are equally possible within the scope of these appended claims.

In the claims, the term “comprises/comprising” does not exclude the presence of other elements or steps. Furthermore, although individually listed, a plurality of means, elements or method steps may be implemented by e.g. a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

1. A method (100) for design and validation of an oligonucleotide array, said method comprising the steps of:
saving (101) information about genome annotations (10) and desired sequences (11) in a first database (12);
constructing (102) a representation matrix for query sequences (14) by applying a second database (13) comprising information about restriction enzymes on said information stored in said first database (12);
constructing (103) a list of restriction enzymes (15) and a list of sequences for profiling (16) based on said representation matrix; and
designing (104) an oligonucleotide array (17) from the list of sequences for profiling (16).

2. The method according to claim 1, wherein said designing (104) an oligonucleotide array (17) comprises the steps of
ranking (42) the sequences of said list of sequences by applying a hybridization model (43) resulting in a second set of sequences suitable for use on a particular oligonucleotide array; and
selecting (44) a desired sequence for said oligonucleotide array (17).

3. The method according to claim 2, wherein said ranking (42) is performed based on at least one of: nucleotide frequency content; exons; promoters; miRNAs; CpG islands; 3′UTR; (histone) acetylation islands; particular histone modification islands; and LINES or SINES.

4. The method according to claim 2, wherein said oligonucleotide array (17) is a microarray comprising an oligonucleotide being a probe.

5. The method according to claim 1, wherein said second database (13) further comprises information regarding a restriction enzyme suitable for designing said oligo-nucleotide array (17) and/or the order of which said restriction enzyme is to be applied.

6. Use of the method according to claim 5, for designing an in silico protocol for validation of oligonucleotide arrays.

7. The method according to claim 1, wherein said oligonucleotide array (17) is an oligonucleotide methylation array.

8. The method according to claim 1, wherein said oligonucleotide array (17) is a gene expression profile.

9. The method according to claim 1, wherein said oligonucleotide array (17) is a genomic profiling array.

10. The method according to claim 9, wherein said genomic profiling array (17) is a single nucleotide polymorphism array or gene copy number polymorphism array.

11. A computer readable medium (200) having embodied thereon a computer program for processing by a processor, said computer program comprising,
a first code segment (201) for saving information about genome annotations (10) and desired sequences (11) in a first database (12);
a second code segment (202) for constructing a representation matrix for query sequences (14) by applying a second database (13) comprising information about restriction enzymes on said information stored in said first database (12);
a third code segment (203) for constructing a list of restriction enzymes (15) and a list of sequences for profiling (16) based on said representation matrix; and
a fourth code segment (204) for designing a DNA array (17) from the list of sequences.

12. A device (300) for validation of an oligonucleotide array, said device comprises
a first unit (301) configured to save information about genome annotations (10) and desired sequences (11) in a first database (12);
a second unit (302) configured to construct a representation matrix for query sequences (14) by applying a second database (13) comprising information about restriction enzymes on said information stored in said first database (12);
a third unit (303) configured to construct a list of restriction enzymes (15) and a list of sequences for profiling (16) based on said representation matrix; and
a fourth unit (304) configured to design an oligonucleotide array (17) from the list of sequences.


SEQUENCE LISTING (2 sequences)

SEQ ID NO: 1 - DNA, 259 bp, Homo sapiens
cggctcgctcgcgaagccacgggcttcactgacgcgactttccaagacgtgggggtcaccatgggcagaggacatcggttcggagccagatcacgggccccataagcatcagaccataagcagcgccgccactgagagccgctcggaactcgcccagcatgtcgggtcccctagccagggcctggtgtacgtggtcgagggccctggaagccccgatggcctaggaggagcaggcgggcggggcggcgggtgtcgctgg

SEQ ID NO: 2 - DNA, 507 bp, Homo sapiens
aaaaaggaaattgagaagaaagaaaatcaaagggaagcaaaatcactcactctcactacctcaagataccctctagaagttggtattttagtgtggttcctattgttttctgtgtcagttctctgatttgagcaaaatctttgggacgtcaaacttaaaatcccctttacttccttggaaaccctgtagcattagcccagacatgtccctactcctccttgtggcaaagagaaggatctcgtctttggtccccagagttctggcctaagcctccctccaggagggaagatgagtgttcagacactcagagtagctgggggagacacaggcctgtgaaattatcctggctcaactattaggtcggcagaatcccagtgaagggagccctacctctgagccccatctaagctttggctatgggtggggcagataagcaggaatccatccctataggctcaatgccaacacccttaggtgaaactcttgatgaaacttgaggccagggct